(19) United States
(12) Patent Application Publication
(10) Pub. No.: US 2010/0031206 A1
(43) Pub. Date: Feb. 4, 2010

(54) METHOD AND TECHNIQUE FOR ANALOGUE CIRCUIT SYNTHESIS

(75) Inventors: Chang-Chung Wu, Hsinchu City (TW); Chi-Che Chen, Hsinchu City (TW); Jung-Chi Ho, Hsinchu City (TW); Woei-Tzy Jong, Hsinchu City (TW); Yeong-Jar Chang, Hsinchu City (TW)

Correspondence Address: WPAT, PC;INTELLECTUAL PROPERTY ATTORNEYS, 7225 BEVERLY ST., ANNANDALE, VA, 22003, US

(73) Assignee: FARADAY TECHNOLOGY CORPORATION, Hsinchu (TW)

(21) Appl. No.: 12/512,086

(22) Filed: Jul. 30, 2009

(30) Foreign Application Priority Data
Jul. 30, 2008 (TW) 097128895

(51) Int. Cl. G06F 17/50

(52) U.S. Cl. 716/2; 716/18; 716/4

(57) ABSTRACT

Method and technique for analogue circuit synthesis. An analogue circuit usually includes many circuit components, and characteristics and functions of each circuit component are controlled by many corresponding parameters. In the presented invention, selected key design parameters of selected critical circuit components, as well as optimization targets, design specification or/and design constraint, are transformed into an optimization plan, and an optimization engine iterates circuit level or system level numerical simulations by changing values of the selected key design parameters recorded in the optimization plan, so as to find optimized parameters and circuit components which allow the analogue circuit to match the design specification/constraint and to approach the optimization target. Thus a systematic automation for analogue circuit synthesis/design/optimization is achieved.

### FIELD OF THE INVENTION

The present invention relates to a method and technology for analogue circuit synthesis, and more particularly, to a simulation-based methodology for analogue circuit synthesis/design/optimization directed by an optimization plan.

### BACKGROUND OF THE INVENTION

Integrated circuit (IC) has become the most important hardware basis of modern information society. As functions of integrated circuits become more complex and diverse in functionality, circuit design becomes more difficult. Therefore, IC designers and design tool developers keep searching for better, more convenient and systematic IC design methodology and technology with higher level automation.

As known by those ordinary skilled in the art, automated circuit synthesis for digital (logic) circuit has been well-developed. Digital circuit designers just describe input-output functionality and related operation constraint (e.g., timing constraint), then software circuit synthesis tool can automatically complete digital circuit synthesis which indicates what kind of circuit components (like logic gates and flip-flops) and what kind of interconnections can be used to satisfy demanded functionality and constraint. In contrast to the well-developed digital circuit synthesis, search for automated analogue circuit synthesis still remains. Because analogue circuit processes signals more complex than digital signals of logic 0 and 1, analogue circuit design is more difficult, and there lacks a general purpose, systematic and automated analogue circuit synthesis methodology in known prior art.

A compiler for PLL (Phase Lock Loop) as an automated PLL circuit synthesis solution is known in prior art. However, this known technology lacks flexibility since it applies only to PLL. A PLL design automation based on geometric programming is also proposed, this technology does not perform numerical circuit simulation, instead it maps circuit parameters and design specification to mathematic equations of specific forms, and the equations are solved to decide circuit parameters. This known art needs complicated mathematic calculation and solution seeking, its performance and practicability are yet to be further proved and verified.

### SUMMARY OF THE INVENTION

It is therefore one of the objectives of the present invention to provide a general purpose, simulation-based and systematic analogue circuit synthesis method and technology to facilitate automation of synthesis/design/optimization of analogue/mixed (mixed with analogue and digital) circuit.

To be more specific, an aspect of the invention is to provide a method for analogue circuit synthesis, wherein the analogue circuit is formed with a plurality of circuit components; functions, operations and characteristics of the plurality of circuit components are determined by a plurality of design parameters, and the invention includes steps of: determining at least a key design parameter from the plurality of design parameters for each critical circuit component after at least a critical circuit component is selected from the plurality of circuit components; transforming the key design parameter and the critical circuit component which are stored in a recordable medium into an optimization plan; and changing values of the key design parameter to do (iterate) a plurality of numerical simulations with an optimization engine according to the optimization plan. In an embodiment of the invention, the optimization plan is a script describing procedures of design/synthesis/optimization flow for analogue circuit synthesis automation. Also at least an optimization target, a test bench indicating items to be monitored in numerical simulations, a technology-dependent data, design specification/constraint and/or an expected operation environment of the analogue circuit can be transformed into the optimization plan. With test bench being tracked by calculating values of the items to be monitored, a combination of critical circuit components and values of their key design parameters can be found to match design specification/constraint in expected operation environment and to approach the optimization target. Thus purposes of automated analogue circuit synthesis/design/optimization are achieved.

Analogue circuit synthesis of the present invention can be performed on circuit level or system level. For example, the optimization plan can record circuit level parameters as key design parameters with each key design parameter being, for example, a dimension, an aspect ratio, a threshold voltage or a process (fabrication) parameter of a transistor, and the optimization engine iterates circuit level numerical simulations, e.g., simulations based on SPICE. Circuit level simulation is advantageous for obtaining more accurate simulation result to simulate operation of transistors and active/passive elements more precisely, though it may also need longer time to finish simulation.

On the other hand, analogue circuit synthesis of the present invention can also perform system level circuit synthesis in coordinate with an analogue database. The analogue database records a plurality of circuit components and system level (and circuit level) information corresponding to each of the plurality of circuit components. Correspondingly, the optimization plan records system level attributes as key design parameters with each key design parameter being a macro characteristic such as a gain, a feedback coefficient, a slew rate, a pole information, a bandwidth, a frequency response, a power consumption or a layout area of a circuit component, and the optimization engine iterates system level numerical simulations according to system level behavior model of analogue circuit. In addition to iterating numerical simulations according to key design parameters recorded in the optimization plan, the optimization engine iterates numerical simulations by further selecting different circuit components from the analogue database to replace a same critical circuit component. Because system level simulation focuses on macro behavior of analogue circuit instead of operation details of individual transistor, active and/or passive element in analogue circuit, system level circuit synthesis tends to be more efficient, and it needs less run time to finish synthesis.

For example, detailed transistor level micro characteristics corresponding to circuit components of specific functions (e.g., an operation amplifier or a switch capacitor circuit component) can be transformed to macro behavior models of system level, such as how parameters of transistors and elements in each circuit component affect whole bandwidth or gain of each circuit component. With system level behavior models, system level numerical simulations (e.g., simulations based on Matlab) are performed according to the optimization plan. If the transistor level micro characteristics can be well transformed to system level behavior models with good precision and accuracy, simulation results of system level will closely approach simulation results of circuit level, and then fast system level simulation can be adopted to approach accuracy of circuit level simulation. In the present invention, system level behavior models, relations between system level and circuit level and modeling technology and knowledge can all be recorded in the analogue database for re-use.

Comparing to application of the analogue database of the present invention, known arts are difficult to systematically compensate gaps between system level and circuit level, resulting greater difference between system level simulation and circuit level simulation; as system level simulation results can not properly predict practical circuit level operations, analogue circuit design becomes more difficult. Designers of known arts usually have to perform over-design for filling gaps between system level and circuit level by further restricting system level specification to a standard higher than originally demanded. However, restricted system level specification usually becomes hard to achieve, or it can not gain optimal cost, layout area and/or power consumption.

A flow control controlling numerical simulations can also be transformed (recorded) into the optimization plan of the present invention. The flow control records at least a step or a plural of steps, wherein different steps respectively record different critical circuit components and corresponding key design parameters. While applying the optimization engine according to the optimization plan, the optimization engine can then iterates numerical simulations by sequentially changing values of the key design parameters in an order corresponding to each step in the flow control.

The present invention also applies for both pre-layout analogue circuit synthesis/design/optimization and post-layout analogue circuit synthesis/design/optimization. Pre-layout synthesis can be performed as discussed above. While applying post-layout synthesis, methodology of the present invention further includes: performing a parasite effect extraction for extracting, from a layout design, circuit parasite effect induced by circuit layout, and then verifying circuit design again with circuit parasite effect considered. If verification fails, the optimization engine works again for iterating numerical simulations following the optimization plan with results obtained in parasite effect extraction. A same optimization plan can be applied to both pre-layout optimization and post-layout optimization, or, alternatively, different optimization plans can be respectively adopted for pre-layout optimization and post-layout optimization. For example, the optimization plan for pre-layout can be fine-tuned to obtain the optimization plan for post-layout.

Another aspect of the present invention is providing a method of high-efficient analogue circuit synthesis for analogue circuit synthesis/design/optimization automation; the method applies to circuit design of either circuit level or system level, as well as pre-layout or post-layout optimization. The method includes: determining at least a key design parameter for each critical circuit component after at least a critical circuit component is selected, transforming the key design parameter and the critical circuit component which are stored in a recordable medium into an optimization plan; and changing values of the key design parameter to do a plurality of numerical simulations with an optimization engine according to the optimization plan. A flow control recording at least a step, wherein different steps respectively record different critical circuit components and corresponding key design parameters, can also be transformed into the optimization plan, so values of the key design parameter(s) can be changed in an order corresponding to each step in the flow control while using the optimization engine. A test bench indicating items to be monitored in the numerical simulation is transformed into the optimization plan, such that a circuit design topology, the optimization plan and the test bench can be integrated while performing analogue circuit design/synthesis/optimization. In addition, the method also includes determining whether an analogue database is used. If the analogue database applies for system level, different circuit components from the analogue database are selected to replace the critical circuit component according to the optimization plan while using the optimization engine.

Knowledge, technology and/or know-how of analogue circuit synthesis can be transformed and/or recorded into the optimization plans and analogue database of the present invention, then reusability of synthesis can be raised to achieve higher productivity of analogue circuit design and better optimized analogue circuit. One key to analogue circuit design is to identify critical circuit components and corresponding key design parameters which dominate behavior of analogue circuit, otherwise analogue designers have to repeat exhausted, non-systematic and time-consuming trial-and-error on every parameter of each circuit component. In contrast, information related to critical circuit component(s) and corresponding key design parameters can be transformed into optimization plans of the present invention. A plurality of optimization plans for synthesizing analogue circuits of a same kind respectively matching various specifications, fabrication scales and process technologies can then be generated from a single optimization plan by merely fine-tuning details in this optimization plan, such as allowable range of each design parameter, test bench, design specification/constraint and fabrication technology-dependent data. In this way, re-usability of synthesis technology can be maximized to reduce time and cost of analogue circuit design and to raise circuit design productivity. The present invention can generally apply to synthesis of various analogue/mixed circuits, such as PLL, analogue-to-digital converter, digital-to-analogue converter and filter, etc.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 illustrates an embodiment of the present invention for analogue circuit synthesis/design/optimization;

FIG. 2 shows an embodiment of the optimization plan shown in FIG. 1 according to the present invention;

FIG. 3 is a diagram of an exemplary analogue circuit;

FIG. 4 is an embodiment of an optimization plan designed for the circuit of FIG. 3 according to the present invention;

FIG. 5 illustrates an embodiment of the analogue database of FIG. 1 according to the present invention; and

FIG. 6 demonstrates an embodiment for pre-layout and post-layout analogue circuit synthesis/design/optimization according to the present invention.

### DETAILED DESCRIPTION OF THE PREFERRED EMBODIMENT

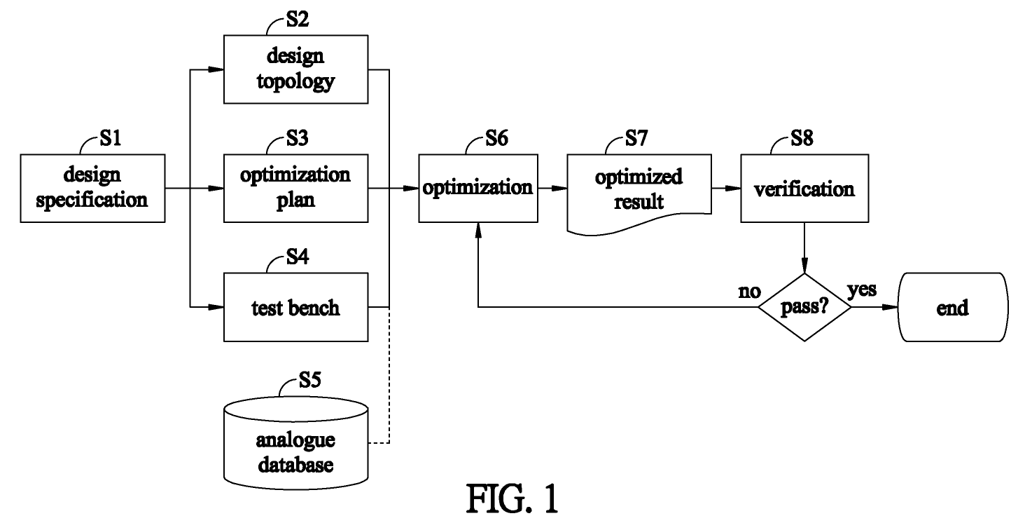

Please refer to FIG. 1, which illustrates key points (procedures/steps) of the proposed method according to an embodiment of the present invention. The proposed method of the present invention applies to analogue circuit synthesis/design/optimization on system level or circuit level, the method includes following points:

Point S1: decide design specification and/or design constraint for the analogue circuit to be synthesized. Analogue circuit design specification/constraint can be decided according to demand and requirement of analogue circuit designers. For example, as a circuit level design/synthesis, design specification for an operation amplifier, which is a specific kind of analogue circuit, usually includes specific gain, slew rate and bandwidth, etc. As an example for system level design/synthesis, design specification for an analogue-to-digital converter, a specific kind of analogue/mixed circuit, usually includes specific signal-to-noise ratio (SNR), over-sampling rate (OSR) and power consumption, etc. Sometime specification (or a portion of specification) is represented as constraint, such as a demand for an SNR lower than a given threshold.

Point S2: decide a circuit design topology for the analogue circuit to be synthesized according to design specification and/or design constraint, i.e., what kinds of circuit components should be included in circuit architecture of the analogue circuit. As a circuit level design/synthesis, circuit components applied usually are passive and/or active elements of transistor level, and the corresponding circuit design topology can be described by, for example, netlists based on hardware description language/format like SPICE (Simulation Program with Integrated Circuit Emphasis). On the other hand, as a system level design/synthesis, circuit components adopted usually are functional building blocks, and the corresponding circuit design topology is described by, for example, algorithms of high level language, such as Matlab (Matrix laboratory, developed by the Mathworks, Inc.).

Point S3: provide an optimization plan. Basically, an optimization plan of the present invention can be considered as a script for directing automated execution of synthesis/design/optimization. Information such as expected operation environment of the analogue circuit to be synthesis (like operation voltages or temperatures), circuit design topology, design specification/constraint, optimization target, fabrication technology-dependent data, critical circuit component(s) and corresponding key design parameter(s), as well as allowable range(s) of each design parameter, can be transformed into the optimization plan. Also, a flow control can be transformed into the optimization plan; the flow control records at least a step or a plural of steps, wherein different steps may respectively record different critical circuit component(s) and corresponding key design parameter(s). According to the flow control, certain circuit component(s) listed in a former step can be fine-tuned to optimization first, and other component(s) listed in a latter step can then be fine-tuned, during analogue circuit synthesis/design/optimization.

As known by those ordinary skilled in the art, an analogue circuit contains a lot of circuit components; operations, characteristics and performance of each circuit component are affected by a lot of corresponding parameters. As a result, each parameter affects macro performance and operation of the whole analogue circuit more or less. Therefore, a key to analogue circuit design is to identify critical circuit components and corresponding key design parameters which dominate behavior of the whole analogue circuit, otherwise analogue designers have to repeat exhausted, non-systematic and time-consuming trial-and-error on every parameter of each circuit component. In the present invention, the optimization plan plays a key roll to record critical circuit component(s) and corresponding key design parameter(s), as well as flow control of optimization flow. In other words, the optimization plan essentially record values, knowledge and flow required to complete an analogue circuit synthesis/design/optimization. The optimization plan can be described by any common script language available, such as tcl (tool command language, created by John Ousterhout) or perl (created by Larry Wall), etc.

Point S4: provide a test bench indicating items to be monitored in the numerical simulations, e.g., current(s) or voltage(s) on given node(s) or gain, etc., of the analogue circuit to be synthesized. During numerical simulations, values of these items in the test bench are calculated and obtained (solved). The test bench can also be transformed into the optimization plan.

Point S5: select where an analogue database should be applied according to whether circuit synthesis/design/optimization is performed on circuit level or system level. If a system level analogue circuit synthesis/design/optimization is required, the analogue database is selected to be applied. The analogue database according to the present invention records a plurality of circuit components of same and/or different functions. For example, the database can records circuit components (e.g., analogue/mixed circuit building blocks) such as current mirrors, differential pairs, bias circuits, operation amplifiers, voltage-controlled oscillators, mixers or PLLs. These circuit components can be optimized (e.g., on circuit level of each circuit component) in advance.

One of the most important features of the analogue database of the present invention is that, each circuit component owns corresponding characterized attributes, i.e., macro behavior attributes modeled and characterized from transistor level characteristics of each circuit component. For example, as a circuit component, an operation amplifier has macro system level attributes (like gain, unit-gain band-width, slew rate, etc.) which are affected by transistor level characteristics such as sizes of transistors, fabrication parameters and technology-dependent characteristics. The relation between transistor level characteristics and system level attributes will be modeled, characterized and recorded in the analogue database of the present invention. In other words, not only transistor level characteristics and parameters of each circuit component, but also corresponding functional blocks (e.g., differential pair(s) and/or bias load(s) included in an operation amplifier), behavior model(s) and/or system level attributes can be recorded in the analogue database of the present invention. Behavior models and functional blocks can be described and recorded with languages based on Matlab.

The analogue database of the present invention can be organized and/or cataloged according to functionality, circuit architecture and/or attribute, such that the optimization engine can automatically select proper circuit component(s) according to various demands (e.g., design specification, test bench, etc.). The analogue database can be implemented by a recordable medium.

Point S6: use the optimization engine for performing numerical simulation(s) to obtain optimized result. In other word, simulation-based optimization engine is adopted for circuit synthesis/design/optimization in the present invention. In modern industry of electronic design automation, numerical simulation is well developed. Therefore, simulation-based optimization can be done by well-developed numerical simulation instead of a new optimization engine developed specially for aforementioned purpose. During optimization, the optimization engine iterates numerical simulations by changing value of each key design parameter (in an order given in the flow control if the flow control exists) according to corresponding allowable range recorded in the optimization plan, and then the items to be monitored in the test bench are obtained to check if the analogue circuit under test matches design specification and/or design constraint. Also, optimization according to the optimization target is performed to approach an optimized circuit design. Operation result(s) of the optimization engine can be recorded in an optimized result, as shown in point S7 of FIG. 1.

For circuit level synthesis/design/optimization, an optimization engine of circuit level simulation based on, e.g., SPICE, can be adopted. For system level analogue circuit synthesis/design/optimization, an optimization engine of system level simulation based on, for example, Matlab, can be adopted to work with the analogue database. During optimization of a critical circuit component, the optimization engine can also iterate numeric simulations by each time replacing the critical circuit component with a circuit component of a same function selected from various circuit components recorded in the analogue database.

Point S7: finish optimization to achieve an optimized result. If optimization successfully completes, it represents that the circuit topology in point S2 can approach the optimization target in point S3. For circuit level synthesis/design/optimization, the optimized result is obtained as a circuit netlist of circuit level, and physical layout dimensions are also obtained. For system level analogue circuit synthesis/design/optimization, system level optimal circuit design is obtained as an optimized result. Because optimization is performed on system level, architecture(s) for implementing system level circuit can be further selected; record(s) in the analogue database can also be adopted to determine how the system level circuit can be implemented. For example, after system level synthesis/design/optimization for a given analogue circuit, a corresponding optimized result may indicate that the given analogue circuit needs an operation amplifier of a specific bandwidth for optimization. While determining how to implement the operation amplification with the specific bandwidth on transistor level architecture, the analogue database can be referred to decide which kinds of transistors, active and/or passive elements are adopted for the operation amplifier.

Point S8: verify the optimized result, that is, verify whether the optimized circuit design correctly satisfies the design specification and/or design constraint. In the present invention, conventional design flow can be adopted for general verification, such as performing one or more numerical simulations to make sure all key design specifications are satisfied. For system level synthesis/design/optimization, optimization is performed on system level, but verification numerical simulation(s) can be performed on circuit level. Meanwhile, if there are more aggressive optimization targets, further optimization and verification can also be performed while implementing system level circuit. After verification passes, analogue circuit synthesis/design/optimization of the present invention is finished.

On the other hand, if verification fails, trouble shooting is performed and the optimization flow restarts accordingly. Possible reasons for verification failure may include: key design specification not constrained in the optimization plan, and/or insufficient accuracy/precision for system level behavior model(s) in the analogue database.

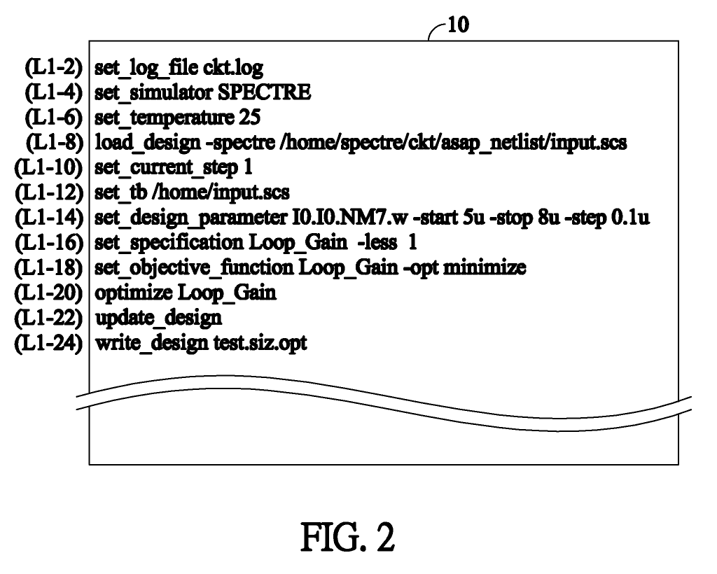

Please refer to FIG. 2, an exemplary optimization plan 10 is demonstrated to explain an embodiment of circuit level synthesis/design/optimization according to the present invention. The optimization plan 10 has plural lines of descriptions L1-2, L1-4 and L1-6, etc., and it is understood that the line numbers L1-2, L1-4 and L1-6, etc., are used for convenience of explanation, they do not imply an execution order. Line L1-2 means execution log of the whole optimization procedure will be kept in file “ckt.log”. Line L1-4 means an optimization engine based on SPECTRE, a circuit simulator similar to SPICE, is adopted for circuit level numerical simulations. Line L1-6 sets an operation temperature of 25 degrees Celsius as one portion of operation environment for the analogue circuit to be synthesized. Line L1-8 loads a circuit design topology (e.g., a netlist) from a file “input.scs”. Line L1-12 loads a test bench from another file “input.scs” of different directory.

Moreover, Line L1-14 identifies a critical circuit component NM7 (e.g., an N-MOS transistor) in the analogue circuit, and indicates its width as a corresponding key design parameter by a description “IO.IO.NM7.w”. For optimization according to the key design parameter, Line L1-14 also has a corresponding description “-start 5 u-stop 8 u-step 0.1 u” for directing the optimization engine to change the key design parameter from 5 um to 8 um by a minimal resolution 0.01 um, so a value of the key design parameter which allows the analogue circuit to approach the optimization target, can be calibrated accordingly. In other words, Line L1-14 records a critical component for the analogue circuit, corresponding key design parameter of the critical component, and an allowable range (“-start 5 u-stop 8 u-step 0.1 u”) of this key design parameter during optimization. Line L1-16 records a description (e.g., a loop gain “Loop_Gain” less than 1) as a portion of the design specification. Lines L1-18 and L1-20 relate to optimization target. Line L1-18 indicates that a minimized loop gain “Loop_Gain” is demanded and Line L1-20 identifies line L1-18 as an optimization target, that is, loop gain is minimized to approach the optimization target.

According to aforementioned descriptions in the optimization plan 10, the optimization engine can iterate numerical simulations by changing value(s) of the key design parameter(s), such that items to be monitored in the test bench are solved, whether the analogue circuit matches design specification and/or design constraint under specified operation environment can be evaluated, and the optimization target can be achieved (reasonably approached). After optimization, optimized circuit design according to the optimized design parameter(s) can be updated and outputted, as indicated by Lines L1-22 and L1-24. And then an analogue circuit synthesis/design/optimization on circuit level is completed.

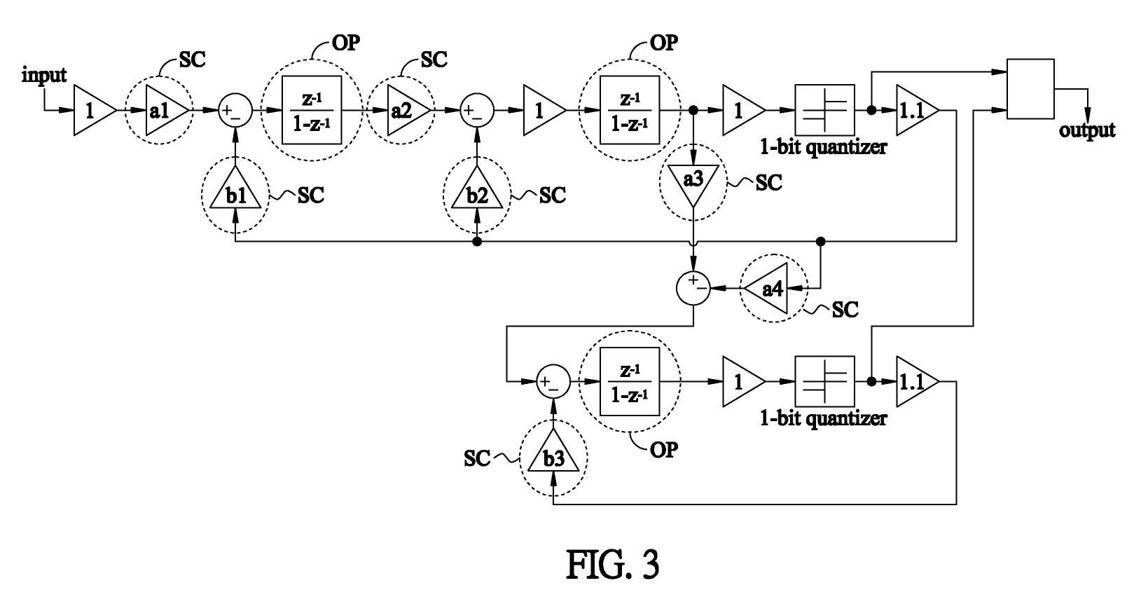

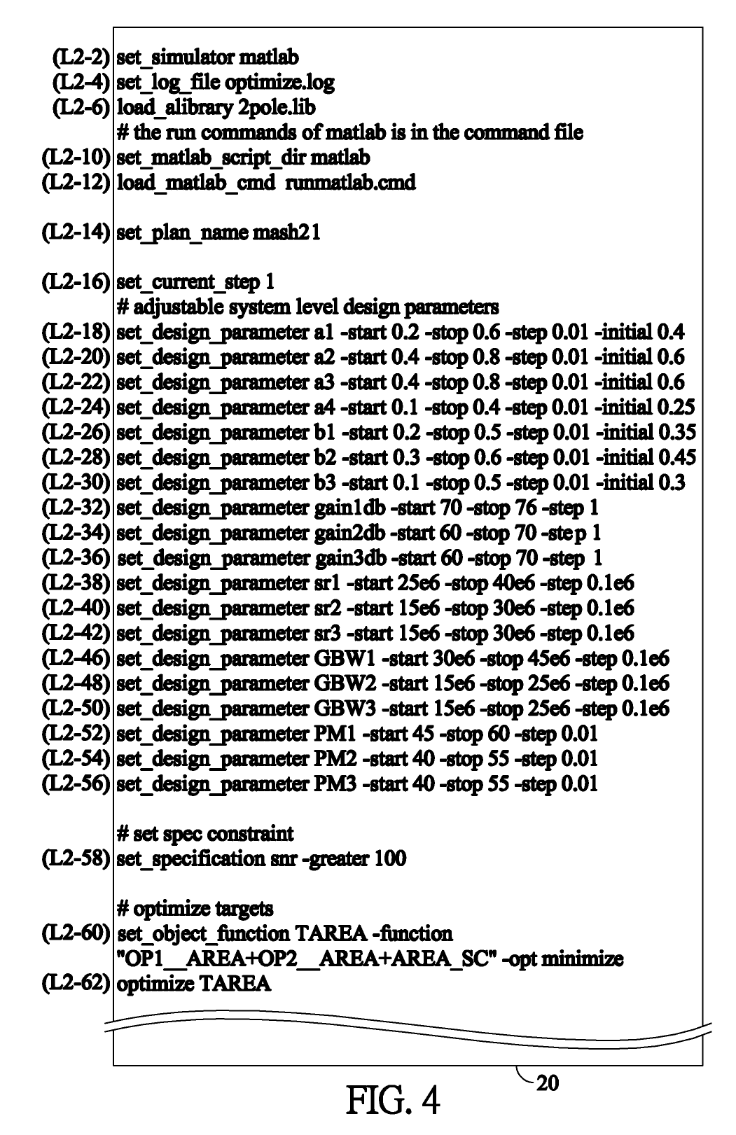

Please refer to FIG. 3 and FIG. 4, which are used as an example to illustrate an embodiment of the present invention applied to system level analogue circuit synthesis/design/optimization. In this example, the invention applies to design a sigma-delta modulator with its system level functional block diagram (circuit topology) shown in FIG. 3. As demonstrated in FIG. 3, the analogue circuit (sigma-delta modulator) has critical circuit components including n integrators OP formed by operation amplifiers with respective transform functions H1(z), H2(z) to Hn(z), as well as 2 n switching capacitors SC noted by “a1”, “a2” to “an” and “b1”, “b2” to “bn”. For system level circuit synthesis/design/optimization, system level characteristic(s) of each integrator OP can be modeled by 4 key system level attributes, i.e., a gain, a unit-gain band-width (UGBW), a slew rate (SR) and a phase margin (PM). On the other hand, each switching capacitor has its system level operation characteristic(s) modeled by a critical system level coefficient. For the whole sigma-delta modulator, effects including non-linear gain and two-pole are considered in the system behavior model according to the invention, so the precision and accuracy of the system level behavior model can be improved, and then numerical simulation results on system level behavior model can closely approach realistic circuit level behavior.

FIG. 4 illustrates an optimization plan 20 for analogue circuit synthesis/design/optimization of the circuit shown in FIG. 3 (n=3 as an example) according to an embodiment of the invention. The optimization plan 20 has plural lines of descriptions L2-2, L2-4, L2-6, etc., and it is understood that these line numbers are labeled for convenience of explanation; they are not necessarily represent execution order. Line L2-2 indicates that the optimization plan will be executed by system level numerical simulations based on high level language Matlab. Line L2-6 loads an analogue database named “analog_op”, which records various operation amplifiers having two poles in this embodiment. Lines L2-18, L2-20, L2-22, L2-24, L2-26, L2-28, L2-30, L2-32, L2-34, L2-36, L2-38, L2-40, L2-42, L2-46, L2-48, L2-50, L2-52, L2-54 and L2-56 respectively record allowable ranges for system level attributes of the integrators OP and switching capacitors SC, that is, allowable ranges for key design parameters of critical circuit components. While executing the optimization plan 20, system level numerical simulations can be iterated by changing values of key design parameters within corresponding allowable ranges. Line L2-58 describes a design specification constraint demanding a signal-to-noise ratio “snr” greater than 100. Moreover, Lines L2-60 and L2-62 relate to optimization target. In this embodiment, the optimization target demands that a total combined layout area of the operation amplifiers and switching capacitors should be minimal, as shown in Line L2-60. Essentially, it demands a minimal layout area of the sigma-delta modulator.

According to the optimization plan 20, the optimization engine can further automatically select applicable operation amplifiers in the analogue database and then iterate system level numerical simulations according to allowable ranges of key design parameters. The numerical simulations test whether the analogue circuit to be synthesized (a sigma-delta modulator in this example) matches required circuit design specification and/or design constraint, also approach the optimization target (minimal total layout area in this example). Because system level simulation is adopted for circuit synthesis/design/optimization, total run time (execution time) of the optimization plan 20 is approximately just 1/10 of run time needed by a single pass of circuit level simulation, and the optimized result on system level closely approaches corresponding circuit level simulation result. As discussed earlier, circuit level simulation can actually simulate operations of transistors, active and/or passive elements with high accuracy and precision, however, it also takes much longer run time to complete execution. System level simulation aims at numerical simulations of system level behavior model, therefore it takes shorter time. Nevertheless, if there is no good supporting measures (such as the analogue database of the present invention), great difference will occur between results obtained by system level simulation and those obtained by circuit level simulation. In known arts, it is difficult to achieve good balance between system level simulation and circuit level simulation; for system level circuit synthesis/design/optimization, designers are usually forced to perform over-design to fill gaps between system level and circuit level by applying more restricted design specification and/or design constraint. Over-design is hard to handle, and highly restricted design specification and/or design constraint will lead to synthesis failure. Moreover, known arts also have difficulty to achieve good balance between circuit level parameters and system level attributes. For example, know arts can not optimize circuit layout area on system level since layout area is affected by parameters (e.g., dimension related parameters) of circuit level.

Comparing to drawbacks of known arts, the present invention resolves the gap between circuit level and system level with a well designed analogue database. In the analogue database of the present invention, circuit level parameters (like layout area and power consumption, etc.,) and system level attributes (such as pole(s), gain and bandwidth, etc.,) of each circuit component are all recorded. Therefore, analogue circuit synthesis/design/optimization of the present invention can obtain a good balance between circuit level and system level. As optimized result of system level can closely approach that of circuit level, advantages of low run time and high accuracy and/or precision are gained, also circuit level optimization target can be achieved on system level.

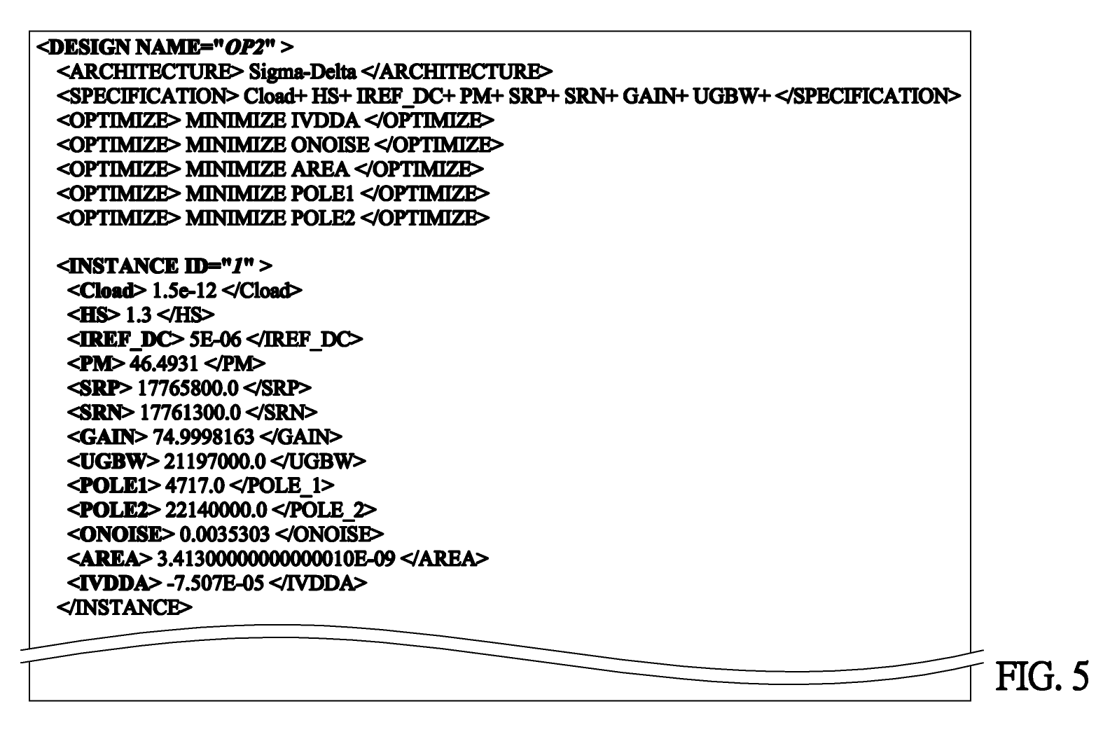

For a further conceptual illustration of the analogue database, please refer to FIG. 5 which demonstrates information built for a given kind of circuit component (operation amplifier with two poles in this example) in the analogue database according to an embodiment of the present invention. Various parameters and characteristics of each circuit component can be described and recorded as information using languages which can catalog information by tags, such as XML (extensible markup language). As shown in FIG. 5, Tag <DESIGN NAME=“OP2”> means that this kind of circuit components is cataloged as operation amplifier “OP2”. Tag <ARCHITECTURE> indicates such kind of circuit component is applicable to sigma-delta modulator. Tag <SPECIFICATION> indicates those specification parameters recorded for such kind of circuit element, e.g., a phase margin (denoted as PM), a gain (denoted by GAIN), a signal-to-noise ratio (denoted as SRN), etc. Tag <OPTIMIZE> indicates which parameters have been optimized for such kind of circuit component. For example, direct-current operation current has been minimized to reduce power consumption, as recorded by “MINIMIZE IVDDA” in FIG. 5; also layout area of each circuit component cataloged under this kind has been minimized, as indicated by “MINIMIZE AREA”. Furthermore, locations of the two poles (related to frequency bandwidth) have been optimized, as denoted by “MINIMIZE POLE1” and “MINIMIZE POLE2”.

On the other hand, Tag <INSTANAT ID=“1”> a first instance of such kind of circuit component, i.e., a first circuit component cataloged under this kind. Information following between header tag <INSTANT ID=“1”> and tail tag </INSTANT> includes various characteristics (values of parameters) of this circuit component instant, e.g., a phase margin PM of 46.4931 degree, a gain GAIN of 74.9998163 and a unit-gain band-width UGBW of 21197000.0 Hz. There can be a lot of instants corresponding to various circuit components cataloged under this kind. Also, different kinds of circuit elements (e.g., bandgap generator, etc.) with corresponding instance(s) can be recorded in the analogue database.

While building the analogue circuit of the invention, technique shown in FIG. 2 can be adopted to automate optimization (and/or parameter calibration) for each circuit component based on corresponding circuit level optimization plans and numerical simulations, and then corresponding system level attributes of each circuit component can be recorded in the analogue database.

In the embodiment of FIG. 3 and FIG. 4, layout area is listed as the optimization target. In fact, while performing analogue circuit synthesis/design/optimization of the invention, an optional flow control can be arranged. The flow control includes plural steps with each step recording corresponding critical circuit element(s), key design parameter(s), design specification, design constraint and/or test bench, thus the whole circuit synthesis/design/optimization flow can be processed step by step. For example, if the analogue circuit to be synthesized has 6 critical circuit components, the flow control can first iterate numerical simulations for key design parameter(s) of the first critical circuit component to approach/achieve design specification, test bench and/or optimization target corresponding to the first critical circuit component. Then, numerical simulations are iterated for key design parameter(s) of the second critical circuit component for its corresponding design specification, test bench and/or optimization target, as so on. In the examples of FIG. 2 and FIG. 4, description “set_current_step 1” in Line L1-10 (FIG. 2) and Line L2-16 (FIG. 4) is used to identify current step as step 1. If plural steps are required in the flow control, similar description is used to respectively set step 2, step 3, etc.

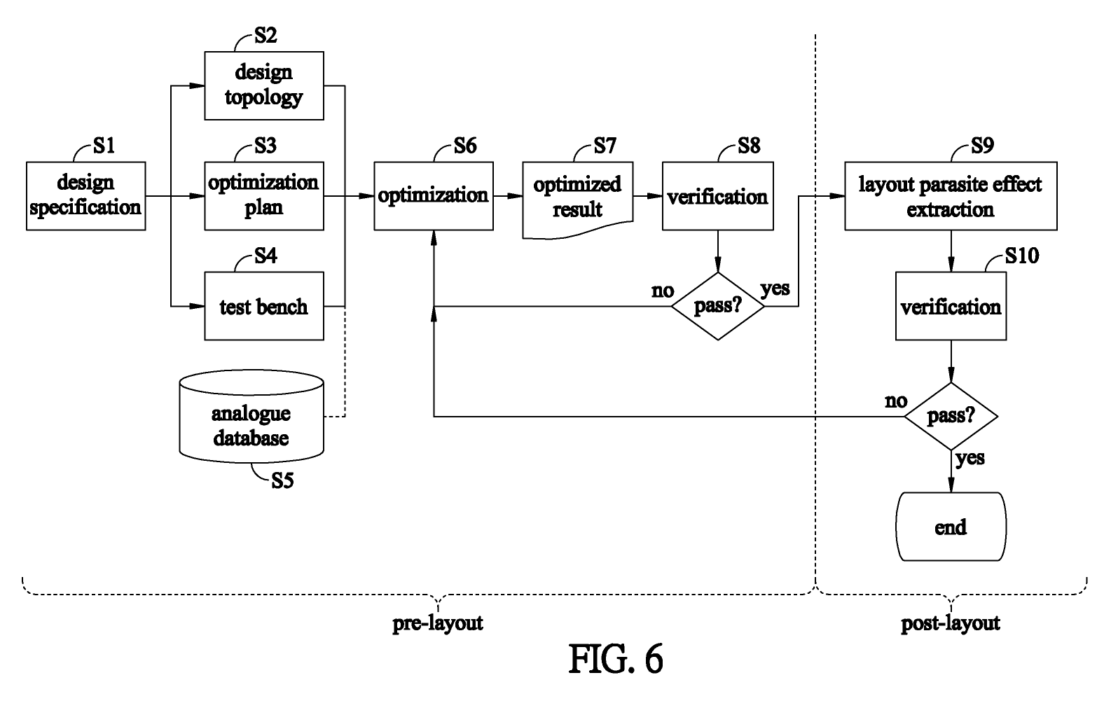

The present invention also applies for both pre-layout analogue circuit synthesis/design/optimization and post-layout analogue circuit synthesis/design/optimization. Pre-layout analogue circuit synthesis/design/optimization is performed according to points shown in FIG. 1. For further post-layout circuit synthesis/design/optimization, additional points shown in FIG. 6 are also applied. Please refer to FIG. 6 (along with FIG. 1); following the embodiment illustrated in FIG. 1, when verification is successfully finished in point S8, pre-layout circuit synthesis/design/optimization is completed. For further post-layout circuit synthesis/design/optimization, following points as shown in FIG. 6 are continued:

Point S9: perform a layout parasite effect extraction. After layout design is completed, circuit parasite effect, introduced by circuit layout such as parasite resistance, capacitance and/or inductance on routings, can then be extracted.

Point S10: repeat verification again with consideration of the extracted parasite effect. That is, equivalent circuitry of parasite effect is added in verification to further explore its affection on the whole analogue circuit to be synthesized. If the verification is successful, post-layout analogue circuit synthesis/design/optimization finishes. Alternatively, if verification fails, the optimization engine performs optimization (following the optimization plan) all over again with consideration of the parasite effect, as shown in FIG. 6. If necessary, the optimization plan applied for this optimization can be fine-tuned by, for example, changing allowable range(s) of some key design parameter(s).

To sum up, comparing to know prior art, circuit level and system level circuit synthesis/design/optimization are closely combined by the analogue database of the invention to gain high efficiency of system level and accuracy/precision of circuit level. The optimization plan of the invention directs automation of analogue circuit synthesis/design/optimization, as well as records knowledge, experiences and know-how of analogue circuit design. In this way, reusability of such technology raises; circuit designers can therefore easily design analogue circuits matching various design specifications, test benches and/or optimization targets for various fabrication technologies by fine-tuning the optimization plans, and then cost and/or resources for analogue circuit synthesis/design/optimization can be effectively reduced. The invention can be implemented by software and/or hardware; for example, each point referred in FIG. 1 and FIG. 6 can be performed through a corresponding module implemented by software tool and/or hardware.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for analogue circuit synthesis, wherein the analogue circuit is formed with a plurality of circuit components and functions and characteristics of the plurality of circuit components are determined by a plurality of design parameters; the method comprising:
determining at least a key design parameter from the plurality of design parameters for each critical circuit component after at least a critical circuit component is selected from the plurality of circuit components;
transforming the key design parameter and the critical circuit component which are stored in a recordable medium into an optimization plan; and
changing values of the key design parameter to do a plurality of numerical simulations with an optimization engine according to the optimization plan.

2. The method of claim 1, wherein the optimization plan is a script describing procedures of design/synthesis/optimization flow for analogue circuit synthesis automation.

3. The method of claim 1, further comprising:
transforming a flow control, an optimization target, a design topology, and a design specification/constraint into the optimization plan.

4. The method of claim 1, further comprising:
transforming a flow control into the optimization plan, wherein the flow control records at least a step and different steps respectively record different critical circuit components and corresponding key design parameters; and
changing values of the key design parameter in an order corresponding to each step in the flow control while using the optimization engine.

5. The method of claim 1 wherein the optimization plan records circuit level parameters as key design parameters with each key design parameter being a dimension, a threshold voltage or a process parameter of a transistor, and the optimization engine iterates circuit level numerical simulations.

6. The method of claim 1 wherein the optimization plan records system level attributes as key design parameters with each key design parameter being a gain, a feedback coefficient, a slew rate, a pole information, a bandwidth, a frequency response, a power consumption or a layout area of a circuit component, and the optimization engine iterates system level numerical simulations.

7. The method of claim 1, further comprising:
providing an analogue database recording a plurality of circuit components and system level information corresponding to each of the plurality of circuit components; and
selecting different circuit components from the analogue database to replace the critical circuit component according to the optimization plan while using the optimization engine.

8. The method of claim 1, further comprising:
deciding a circuit design topology of the analogue circuit.

9. The method of claim 1 further comprising:
transforming a test bench indicating a plurality of items to be monitored in the numerical simulations into the optimization plan.

10. The method of claim 9 further comprising:
calculating values of the plurality of items to be monitored in the test bench while using the optimization engine.

11. The method of claim 1, further comprising:
transforming a technology-dependent data and/or an operation environment of the analogue circuit into the optimization plan.

12. The method of claim 1, which is applied for a pre-layout optimization.

13. The method of claim 1, which is applied for a post-layout optimization, further comprising:
extracting circuit parasite effect induced by circuit layout from a layout design.

14. A method of high-efficient analogue circuit synthesis for analogue circuit synthesis/design/optimization automation; wherein the method applies to circuit design of either circuit level or system level, as well as pre-layout or post-layout optimization; the method comprising:
determining at least a key design parameter for each critical circuit component after at least a critical circuit component is selected;
transforming the key design parameter and the critical circuit component which are stored in a recordable medium into an optimization plan; and
changing values of the key design parameter to do a plurality of numerical simulations with an optimization engine according to the optimization plan.

15. The method of claim 14, wherein the optimization plan is a script describing procedures of design/synthesis/optimization flow for analogue circuit synthesis automation.

16. The method of claim 14, further comprising:
transforming a flow control into the optimization plan, wherein the flow control records at least a step and different steps respectively record different critical circuit components and corresponding key design parameters; and
changing values of the key design parameter in an order corresponding to each step in the flow control while using the optimization engine.

17. The method of claim 14 wherein the optimization plan records circuit level parameters as key design parameters with each key design parameter being a dimension, a threshold voltage or a process parameter of a transistor, and the optimization engine iterates circuit level numerical simulations.

18. The method of claim 14 wherein the optimization plan records system level attributes as key design parameters with each key design parameter being a gain, a feedback coefficient, a slew rate, a pole information, a bandwidth, a frequency response, a power consumption or a layout area of a circuit component, and the optimization engine iterates system level numerical simulations.

19. The method of claim 14, further comprising:
providing an analogue database recording a plurality of circuit components and system level information corresponding to each of the plurality of circuit components; and
selecting different circuit components from the analogue database to replace the critical circuit component according to the optimization plan while using the optimization engine.

20. The method of claim 14, further comprising:
transforming a test bench indicating items to be monitored in the numerical simulations into the optimization plan;
integrating a circuit design topology, the optimization plan and the test bench while performing circuit design/synthesis/optimization of an analogue circuit; and
determining whether an analogue database is used to perform an simulation-based optimization flow.
